(19) United States
(12) Patent Application Publication
(10) Pub. No.: US 2022/0324007 A1
(43) Pub. Date: Oct. 13, 2022

(54) FORMING SYSTEM AND FORMING METHOD

(71) Applicant: SUMITOMO HEAVY INDUSTRIES, LTD., Tokyo (JP)

(72) Inventor: Masayuki Saika, Ehime (JP)

(21) Appl. No.: 17/847,370

(22) Filed: Jun. 23, 2022

Related U.S. Application Data
(63) Continuation of application No. PCT/JP2021/008833, filed on Mar. 5, 2021.

(30) Foreign Application Priority Data
Mar. 10, 2020 (JP) 2020-040979

(51) Int. Cl. B21D 26/035; B21D 26/047; B23P 23/04; B21D 37/16

(52) U.S. Cl. CPC B21D 26/035; B21D 26/047; B23P 23/04; B21D 37/16

(57) ABSTRACT

Provided is a forming system including: a forming device including a fluid supply unit that supplies a fluid to a heated metal pipe material, and a forming die that forms a formed product by bringing an expanded metal pipe material into contact with a forming surface; a machining unit that machines the formed product removed from the forming die; and a scale removing unit that removes scales from the formed product machined by the machining unit.

### RELATED APPLICATIONS

The contents of Japanese Patent Application No. 2020-040979, and of International Patent Application No. PCT/JP2021/008833, on the basis of each of which priority benefits are claimed in an accompanying application data sheet, are in their entirety incorporated herein by reference.

### BACKGROUND

### Technical Field

Certain embodiments of the present invention relate to a forming system and a forming method.

### Description of Related Art

In the related art, a forming system described in the related art is known. The forming system includes a forming device. The forming system includes a forming device including a fluid supply unit that supplies a fluid to a heated metal pipe material, and a forming die that forms a formed product by bringing an expanded metal pipe material into contact with a forming surface. In this way, the forming system can bring the heated metal pipe material into contact with the forming die to perform the forming and simultaneously perform hardening.

### SUMMARY

According to one aspect of the present invention, there is provided a forming system including: a forming device including a fluid supply unit that supplies a fluid to a heated metal pipe material, and a forming die that forms a formed product by bringing an expanded metal pipe material into contact with a forming surface; a machining unit that machines the formed product removed from the forming die; and a scale removing unit that removes scales from the formed product machined by the machining unit.

According to another aspect of the present invention, there is provided a forming method including: a forming process of supplying a fluid to a heated metal pipe material and bringing an expanded metal pipe material into contact with a forming surface of a forming die to form a formed product; a machining process of machining the formed product removed from the forming die; and a scale removing process of removing scales from the formed product machined in the machining process.

### BRIEF DESCRIPTION OF THE DRAWINGS

FIG. 1 is a schematic configuration diagram showing a configuration of a forming system according to one embodiment.

FIG. 2 is a schematic diagram of a forming device used in the forming system according to the present embodiment.

FIGS. 3A and 3B are enlarged cross-sectional views showing a state of a metal pipe material and a forming die during blow forming.

FIGS. 4A and 4B are perspective views showing an aspect of laser machining by a laser machining device.

FIGS. 5A and 5B are conceptual diagrams showing an aspect of blasting by a blasting device.

FIG. 6 is a process diagram showing a forming method according to the one embodiment.

FIG. 7 is a schematic configuration diagram showing a configuration of a forming system according to another embodiment.

FIG. 8 is a schematic configuration diagram showing a configuration of a forming system according to still another embodiment.

FIG. 9 is a schematic diagram of a forming device according to a modification example.

FIGS. 10A and 10B are views showing an example of a structure around a nozzle for supplying gas.

### DETAILED DESCRIPTION

Here, in the forming system described in the related art mentioned above, the heated metal pipe material is formed while being hardened using the forming die. Therefore, scales (oxidized scales) are generated in the formed product. There is a case where the forming system includes a scale removing unit to remove such scales from the formed product. There has been a need to improve the efficiency of scale removal by the scale removing unit.

It is desirable to provide a forming system and a forming method capable of improving the efficiency of scale removal.

In the forming system, the forming device supplies the fluid to the heated metal pipe material to expand the metal pipe material to form the heated metal pipe material with the forming die. Therefore, the scales are generated on the surface of the formed product. In contrast, the machining unit machines the formed product removed from the forming die. Additionally, the scale removing unit removes the scales from the formed product machined by the machining unit. In this way, the machining unit machines the formed product in a stage before the scales are removed. In this case, the machining unit can reduce the area serving as a target for scale removal as compared to the formed product immediately after the forming. Therefore, the scale removing unit can perform processing for scale removal on the formed product in which the area serving as a target for scale removal becomes smaller. Accordingly, the scale removing unit can perform the scale removal in a shorter time with a smaller device than performing the processing for scale removal on the formed product immediately after the forming. From the above, the efficiency of the scale removal can be improved.

The scale removing unit may remove the scales from the formed product by causing particles to collide against the formed product. In this case, the scale removing unit can remove burrs, spatters, dross, or the like generated with machining due to the collision of the particles, and can flatten the surface.

The forming system may further include a cooling unit that actively cools the formed product removed from the forming die, and the machining unit may machine the formed product cooled by the cooling unit. For example, in a case where the machining unit performs the machining using a laser beam, it is necessary to lower the temperature of the formed product to room temperature. By actively cooling the formed product via the cooling unit, it is possible to reduce the time required for the machining as compared to a case where heat naturally dissipates.

According to the forming method, the same operation and effects as those of the above-described forming system can be obtained.

Hereinafter, preferred embodiments of the present invention will be described with reference to the drawings. In addition, in the respective drawings, the same portions or corresponding portions are designated by the same reference numerals, and duplicate descriptions will be omitted.

### One Embodiment

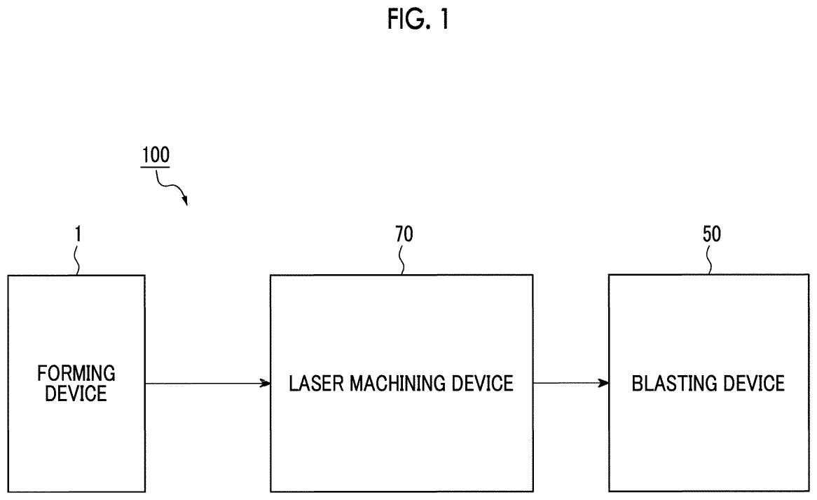

FIG. 1 is a schematic configuration diagram showing the configuration of a forming system 100 according to one embodiment. As shown in FIG. 1, the forming system 100 includes a forming device 1, a laser machining device 70 (machining unit), and a blasting device 50 (scale removing unit).

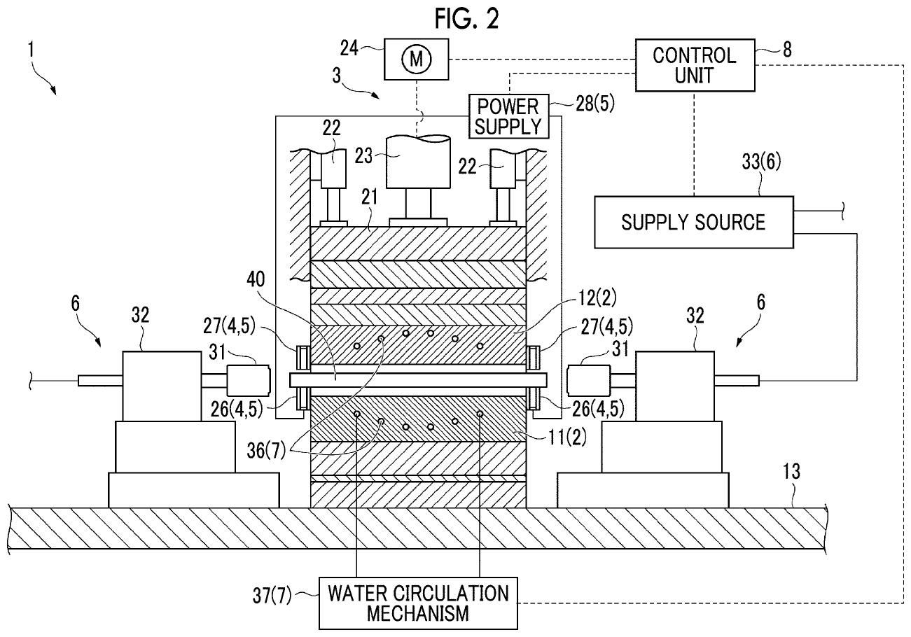

The forming device 1 is a device that forms a heated metal material with a forming die. In the present embodiment, a STAF forming device, which performs the forming and hardening by supplying a fluid to a heated metal pipe material to bring the fluid into contact with a forming surface of the forming die, is adopted as the forming device 1. The detailed configuration of the forming device 1 will be described with reference to FIG. 2.

FIG. 2 is a schematic diagram of the forming device 1 used in the forming system 100 according to the present embodiment. As shown in FIG. 2, the forming device 1 is a device that forms a metal pipe (formed product) having a hollow shape via blow forming. In the present embodiment, the forming device 1 is installed on a horizontal plane. The forming device 1 includes a forming die 2, a drive mechanism 3, a holding unit 4, a heating unit 5, a fluid supply unit 6, a cooling unit 7, and a control unit 8. In addition, in the present specification, a metal pipe material 40 (metal material) refers to a hollow article before the completion of the forming by the forming device 1. The metal pipe material 40 is a steel type pipe material that can be hardened. Additionally, in a horizontal direction, a direction in which the metal pipe material 40 extends during forming may be referred to as a “longitudinal direction”, and a direction perpendicular to the longitudinal direction may be referred to as a “width direction”.

The forming die 2 is a die that forms a metal pipe 140 from the metal pipe material 40, and includes a lower die 11 and an upper die 12 that face each other in a vertical direction. The lower die 11 and the upper die 12 are made of steel blocks. Each of the lower die 11 and the upper die 12 is provided with a recessed part in which the metal pipe material 40 is accommodated. With the lower die 11 and the upper die 12 in close contact with each other (die closed state), respective recessed parts thereof form a space having a target shape in which the metal pipe material is to be formed. Therefore, the surfaces of the respective recessed parts become the forming surfaces of the forming die 2. The lower die 11 is fixed to a base stage 13 via a die holder or the like. The upper die 12 is fixed to a slide of the drive mechanism 3 via a die holder or the like.

The drive mechanism 3 is a mechanism that moves at least one of the lower die 11 and the upper die 12. In FIG. 2, the drive mechanism 3 has a configuration in which only the upper die 12 is moved. The drive mechanism 3 includes a slide 21 that moves the upper die 12 such that the lower die 11 and the upper die 12 are joined together, a pull-back cylinder 22 serving as an actuator that generates a force for pulling the slide 21 upward, a main cylinder 23 serving as a drive source that downward-pressurizes the slide 21, and a drive source 24 that applies a driving force to the main cylinder 23.

The holding unit 4 is a mechanism that holds the metal pipe material 40 disposed between the lower die 11 and the upper die 12. The holding unit 4 includes a lower electrode 26 and an upper electrode 27 that hold the metal pipe material 40 on one end side in the longitudinal direction of the forming die 2, and a lower electrode 26 and an upper electrode 27 that hold the metal pipe material 40 on the other end side in the longitudinal direction of the forming die 2. The lower electrodes 26 and the upper electrodes 27 on both sides in the longitudinal direction hold the metal pipe material 40 by sandwiching the area around an end portion of the metal pipe material 40 from the vertical direction. In addition, groove portions having a shape corresponding to an outer peripheral surface of the metal pipe material 40 are formed on an upper surface of the lower electrode 26 and a lower surface of the upper electrode 27. The lower electrode 26 and the upper electrode 27 are provided with drive mechanisms (not shown) and are movable independently in the vertical direction.

The heating unit 5 heats the metal pipe material 40. The heating unit 5 is a mechanism that heats the metal pipe material 40 by energizing the metal pipe material 40. The heating unit 5 heats the metal pipe material 40 in a state where the metal pipe material 40 is spaced apart from the lower die 11 and the upper die 12 between the lower die 11 and the upper die 12. The heating unit 5 includes the lower electrodes 26 and the upper electrodes 27 on both sides in the longitudinal direction described above, and a power supply 28 that allows an electric current to flow to the metal pipe material 40 through the electrodes 26 and 27. In addition, the heating unit may be disposed in the previous process of the forming device 1 and performs heating externally.

The fluid supply unit 6 is a mechanism that supplies a high-pressure fluid into the metal pipe material 40 held between the lower die 11 and the upper die 12. The fluid supply unit 6 supplies the high-pressure fluid to the metal pipe material 40 that has been brought into a high-temperature state by being heated by the heating unit 5, and expands the metal pipe material 40. The fluid supply unit 6 is provided on both end sides of the forming die 2 in the longitudinal direction. The fluid supply unit 6 includes a nozzle 31 that supplies fluid from an opening of an end portion of the metal pipe material 40 to the inside of the metal pipe material 40, a drive mechanism 32 that moves the nozzle 31 forward and backward with respect to the opening of the metal pipe material 40, and a supply source 33 that supplies the high-pressure fluid into the metal pipe material 40 via the nozzle 31. In the drive mechanism 32, the nozzle 31 is brought into close contact with the end portion of the metal pipe material 40 in a state where the sealing performance is secured during fluid supply and exhaust, and at other times, the nozzle 31 is spaced apart from the end portion of the metal pipe material 40. In addition, the fluid supply unit 6 may supply a gas such as high-pressure air or an inert gas as the fluid. Additionally, the fluid supply unit 6 may be the same device including the heating unit 5 together with the holding unit 4 having a mechanism that moves the metal pipe material 40 in the vertical direction.

The cooling unit 7 is a mechanism that cools the forming die 2. By cooling the forming die 2, the cooling unit 7 can rapidly cool the metal pipe material 40 when the expanded metal pipe material 40 has come into contact with a forming surface of the forming die 2. The cooling unit 7 includes a flow path 36 formed inside the lower die 11 and the upper die 12, and a water circulation mechanism 37 that supplies and circulates cooling water to the flow path 36.

The control unit 8 is a device that controls the entire forming device 1. The control unit 8 controls the drive mechanism 3, the holding unit 4, the heating unit 5, the fluid supply unit 6, and the cooling unit 7. The control unit 8 repeatedly performs an operation of forming the metal pipe material 40 with the forming die 2.

Specifically, the control unit 8 controls, for example, the transport time from a transport device such as a robot arm to dispose the metal pipe material 40 between the lower die 11 and the upper die 12 in an open state. Alternatively, in the control unit 8, a worker may manually dispose the metal pipe material 40 between the lower die 11 and the upper die 12. Additionally, the control unit 8 supports the metal pipe material 40 with the lower electrodes 26 on both sides in the longitudinal direction, and then controls the actuator of the holding unit 4 so as to lower the upper electrode 27 to sandwich the metal pipe material 40. Additionally, the control unit 8 controls the heating unit 5 to energize and heat the metal pipe material 40. Accordingly, an axial electric current flows through the metal pipe material 40, and the electric resistance of the metal pipe material 40 itself causes the metal pipe material 40 itself to generate heat due to Joule heat.

The control unit 8 controls the drive mechanism 3 to lower the upper die 12 and bring the upper die 12 closer to the lower die 11 to close the forming die 2. On the other hand, the control unit 8 controls the fluid supply unit 6 to seal the openings of both ends of the metal pipe material 40 with the nozzle 31 and to supply the fluid. Accordingly, the metal pipe material 40 softened by heating expands and comes into contact with the forming surface of the forming die 2. Then, the metal pipe material 40 is formed so as to follow the shape of the forming surface of the forming die 2. In addition, in a case where a metal pipe with a flange is formed, a part of the metal pipe material 40 is made to enter a gap between the lower die 11 and the upper die 12, and then the die is further closed to crush the entering portion to form a flange portion. When the metal pipe material 40 comes into contact with the forming surface, hardening of the metal pipe material 40 is performed by being quenched with the forming die 2 cooled by the cooling unit 7.

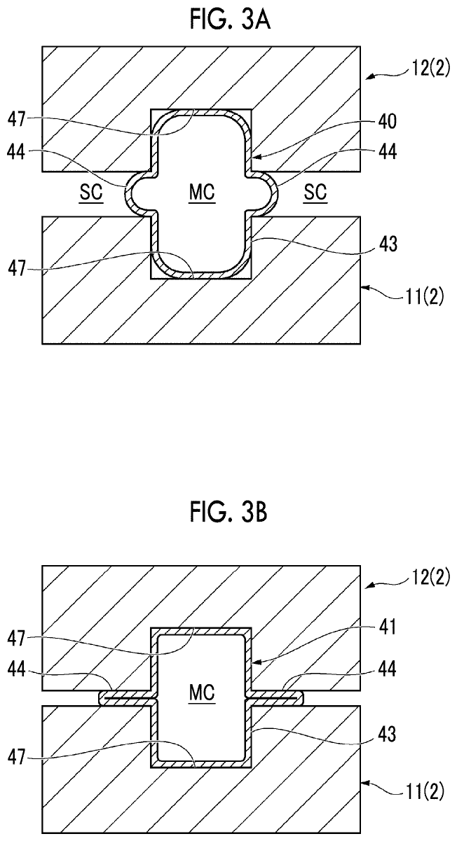

A forming procedure of the forming device 1 will be described with reference to FIGS. 3A and 3B. As shown in FIG. 3A, the control unit 8 performs blow forming (primary blowing) by closing the forming die 2 and supplying the fluid to the metal pipe material 40 via the fluid supply unit 6. In the primary blowing, the control unit 8 forms a pipe portion 43 at a main cavity portion MC and causes a portion corresponding to a flange portion 44 to enter a sub-cavity portion SC. Then, as shown in FIG. 3B, the control unit 8 forms the flange portion 44 by further closing the forming die 2 and further crushing the portion that has entered the sub-cavity portion SC. Next, the control unit 8 performs die opening by raising the upper die 12 to space the upper die 12 apart from the metal pipe material 40. Accordingly, a formed product 41 is formed.

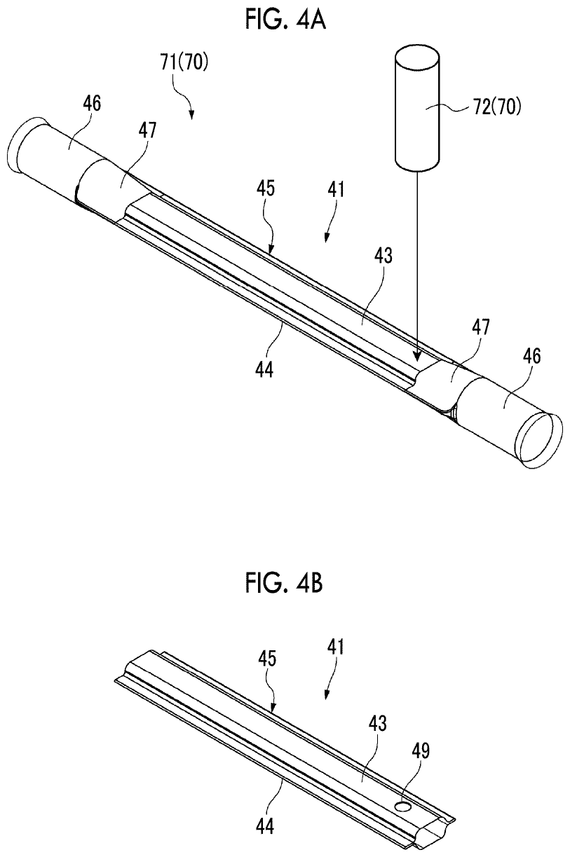

The formed product 41 will be described with reference to FIG. 4A. The formed product 41 includes a formed body portion 45 having the pipe portion 43 and the flange portion 44, held portions 46 on both end sides in the longitudinal direction, and a gradual change portion 47 between the formed body portion 45 and the held portion 46. The formed body portion 45 is a portion that becomes a final product by being laser-machined. The pipe portion 43 is a hollow portion. The flange portion 44 is a plate-shaped portion that protrudes from the pipe portion 43 by crushing a part of the metal pipe material 40. The held portion 46 is a cylindrical portion that is held by the electrodes 26 and 27. The nozzle 31 is inserted into the held portion 46. The gradual change portion 47 is a transition portion that changes from the shape of the held portion 46 to the shape of the formed body portion 45.

Returning to FIG. 1, the formed product 41 formed by the forming device 1 is supplied to the laser machining device 70. The formed product 41 may be sequentially supplied to the laser machining device 70 from the ones formed by the forming device 1. Alternatively, after a certain amount of formed products 41 are accumulated in an accumulation place, the formed products may be collectively supplied to the laser machining device 70. Ina case where the formed product 41 is accumulated, the temperature of the formed product 41 can be lowered before the laser machining due to the cooling effect of natural heat dissipation.

The laser machining device 70 is a device that machines the formed product 41 removed from the forming die 2 with a laser beam. The laser machining device 70 irradiates the formed product 41 with a laser beam to perform machining such as cutting, drilling, and cutout formation.

FIGS. 4A and 4B are perspective views showing an aspect of the laser machining by the laser machining device 70. As shown in FIG. 4A, the laser machining device 70 includes an installation portion 71 and a laser head 72. The installation portion 71 is a portion where the formed product 41 is installed at a position facing the laser head 72. The installation portion 71 has a support portion (not shown), and supports the formed product 41 with the support portion. Accordingly, the formed product 41 is installed in the installation portion 71 at a position and in a posture suitable for the laser machining. The laser head 72 is a portion that machines the formed product 41 by irradiating the formed product 41 with a laser beam.

The laser head 72 removes the gradual change portion 47 and the held portion 46 from the formed body portion 45 by cutting areas around both end portions of the formed body portion 45 as shown in FIG. 4B. Additionally, the laser head 72 forms a hole 49 at a predetermined position of the formed body portion 45.

Returning to FIG. 1, the formed product 41 machined by the laser machining device 70 is supplied to the blasting device 50. The formed product 41 may be sequentially supplied to the blasting device 50 in order from the ones machined by the laser machining device 70. Alternatively, after a certain amount of formed products 41 are accumulated in the accumulation place, the formed products may be collectively supplied to the blasting device 50.

The blasting device 50 is a device that removes scales from the formed product 41 machined by the laser machining device 70. The scales are an oxide film formed on the surface of the metal pipe material 40 by heating the metal pipe material 40 in the forming device 1. The blasting device 50 jets particles onto the surface of the formed product 41. The blasting device 50 removes the scales from the surface of the formed product 41 via the impact caused by the collision of the particles.

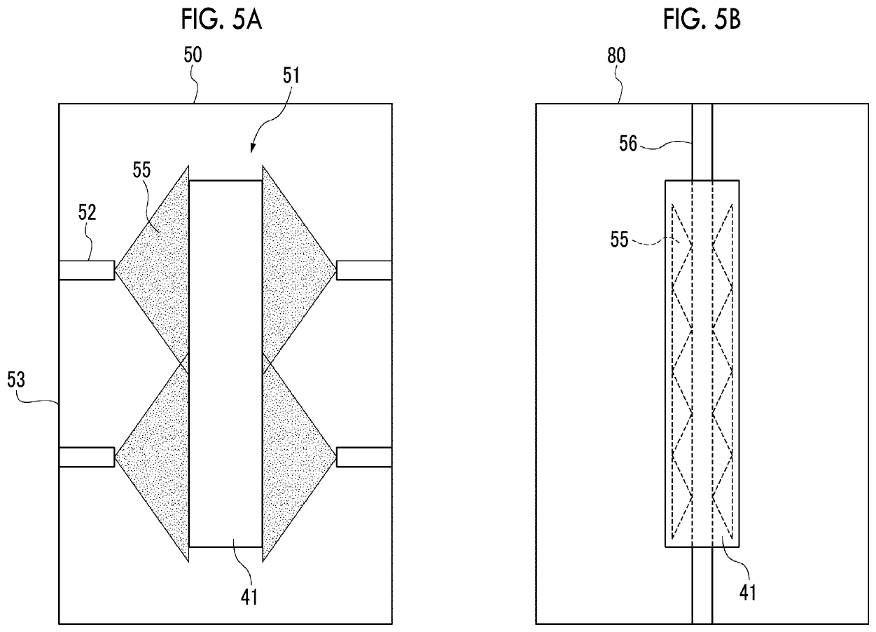

FIG. 5A is a schematic diagram showing the blasting device 50 of the present embodiment. The blasting device 50 according to the present embodiment removes the scales on an outer peripheral surface of the formed product 41. On the other hand, the blasting device 50 does not jet particles onto the inner peripheral surface so as not to leave the particles inside the formed product 41. For example, as shown in FIGS. 4A and 4B, the formed product 41 has the flange portion 44 by crushing a part of the metal pipe material 40. In an internal space of the formed product 41, the particles tend to remain in such a flange portion 44. Therefore, the blasting device 50 jets the particles only onto the outer peripheral surface of the formed product 41.

As shown in FIG. 5A, the blasting device 50 has the installation portion 51, a nozzle 52, and a blockade wall 53. The installation portion 51 is a portion where the formed product 41 is installed at a position facing the nozzle 52. The installation portion 51 has a support portion (not shown), and supports the formed product 41 with the support portion. Accordingly, the formed product 41 is installed in the installation portion 51 at a position and in a posture suitable for the blasting. The installation portion 51 suspends the formed product 41 and installs the formed product in a posture that extends in the vertical direction. The nozzle 52 is a member that jets the formed product 41 with particles 55. As the particles, for example, materials such as sand, plastic, dry ice, and iron pieces are adopted. The nozzle 52 is disposed around the formed product 41 installed in the installation portion 51. The nozzle 52 is disposed such that a jetting port faces the outer peripheral surface of the formed product 41. Accordingly, the nozzle 52 can jet the particles 55 onto the outer peripheral surface of the formed product 41.

The blockade wall 53 is a wall body that blocks the particles 55. The blockade wall 53 is disposed so as to surround the peripheries of the installation portion 51 and the nozzle 52. Accordingly, the blockade wall 53 can prevent the particles 55 from being scattered around the blasting device 50. That is, the blockade wall 53 can prevent the particles 55 from being scattered to the forming device 1 and to the laser machining device 70. In addition, a wall portion that partitions a space between the blasting device 50 and the laser machining device 70 may be provided in addition to the blockade wall 53.

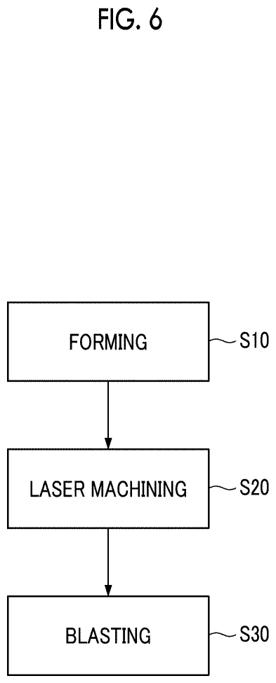

Next, a forming method according to the present embodiment will be described with reference to FIG. 6. FIG. 6 is a process diagram showing the forming method according to the present embodiment. As shown in FIG. 6, the forming method includes a forming process S10, a laser machining process S20 (machining process), and a blasting process S30 (scale removing process). In the forming process S10, the fluid is supplied to the heated metal pipe material 40, and the expanded metal pipe material 40 is brought into contact with the forming surface of the forming die 2 to form the formed product 41. In the forming process S10, the formed product 41 is formed using the forming device 1 shown in FIG. 2. The laser machining process S20 is a process of machining the formed product 41 removed from the forming die 2. In the laser machining process S20, the laser machining device 70 shown in FIGS. 4A and 4B performs machining of the formed product 41. The blasting process S30 is a process of removing scales from the formed product 41 machined in the laser machining process S20. In the blasting process S30, the blasting device 50 shown in FIG. 5A performs blasting processing to remove the scales from the formed product 41.

Next, the operation and effects of the forming system 100 and the forming method according to the present embodiment will be described.

In the forming system 100, the forming device 1 supplies the fluid to the heated metal pipe material 40 to expand the metal pipe material 40 to form the heated metal pipe material 40 with the forming die 2. Therefore, the scales are generated on the surface of the formed product 41. In contrast, the laser machining device 70 machines the formed product 41 removed from the forming die 2. Additionally, the blasting device 50 removes the scales from the formed product 41 machined by the laser machining device 70. In this way, the laser machining device 70 machines the formed product 41 in the stage before the scales are removed. In this case, the laser machining device 70 can reduce the area serving as a target for scale removal as compared to the formed product 41 immediately after the forming. Therefore, the blasting device 50 can perform the processing for scale removal on the formed product 41 in which the area serving as a target for scale removal becomes smaller. Accordingly, the blasting device 50 can perform the scale removal in a shorter time with a smaller device than performing the processing for scale removal on the formed product 41 immediately after the forming. From the above, the efficiency of the scale removal can be improved.

For example, in a case where the blasting is performed before the machining is performed by the laser machining device 70, the blasting device 50 will perform the blasting up to non-product portions such as the gradual change portion 47 and the held portion 46. In a case where the formed product 41 is hung by a hanger method as shown in FIGS. 5A and 5B, it is necessary to set the height and width of the blasting device 50 in consideration of non-product portions at both ends of the formed body portion 45. Additionally, in a case where the inner peripheral surface of the formed product 41 is subjected to the blasting, the length of a blast hose 56 is a length in which even the non-product portions are taken into consideration. In contrast, in the forming system 100 according to the present embodiment, the blasting is performed after the non-product portions are cut in advance. Therefore, the blasting device 50 can be downsized, and the blasting time is shortened by reducing the blasting range.

The blasting device 50 may remove the scales from the formed product 41 by causing the particles to collide against the formed product 41. In this case, the blasting device 50 can remove burrs, spatters, dross, or the like generated with machining due to the collision of the particles, and can flatten the surface.

Additionally, in the formed product 41, there is a possibility that the periphery of a spot cut by the laser machining is tempered due to the influence of heat, or that the surface is roughened by the laser machining. In contrast, the blasting device 50 can perform the blasting after the laser machining to flatten the surface by the blasting or to achieve a shot peening effect via work hardening. Additionally, from the viewpoint of the freezing property of the shape, it is possible to suppress a slight change in the shape from the blasted shape, and it is possible to suppress a variation in the quality of the final shape of the formed product 41. Additionally, for example, there is a case where the formed product 41 is marked to indicate a reference position for the laser machining. In a case where the blasting is performed before the laser machining, there is a possibility that the marking becomes thin and is difficult to read. In contrast, since the laser machining device 70 performs the machining in the stage before the blasting, the marking can be read in an easy-to-read state. Therefore, the machining accuracy of the laser machining device 70 is improved.

### Another Embodiment

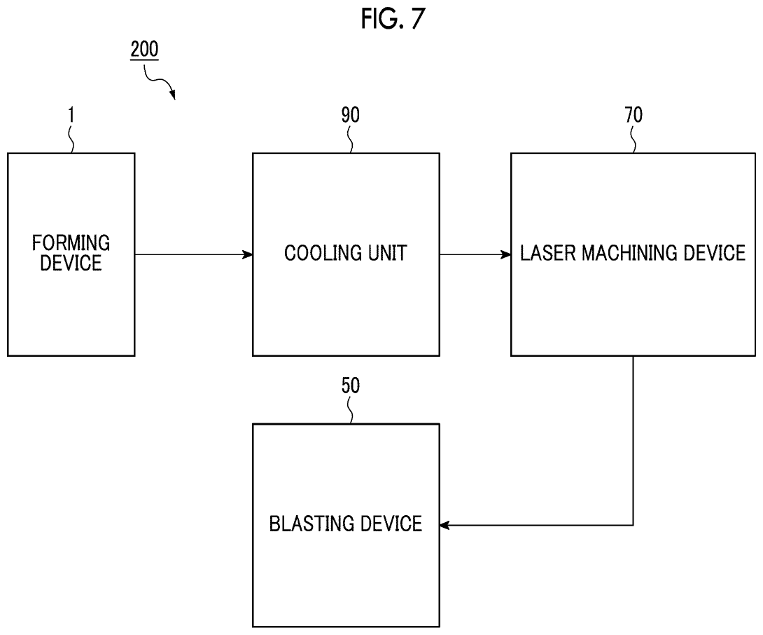

Next, a forming system 200 according to another embodiment will be described with reference to FIG. 7. As shown in FIG. 7, the forming system 200 includes a cooling unit 90 that actively cools the formed product 41 removed from the forming die 2, in a stage before the laser machining device 70.

The active cooling means that the formed product 41 is cooled with a higher cooling capacity than that of leaving the formed product 41 at room temperature by performing active treatment on the formed product 41. As such a cooling unit 90, a mechanism that supplies a cooling medium such as cold air, cold water, ice, and dry ice to the formed product 41 may be adopted. For example, in a case where there is a transport facility up to the laser machining device 70, the cooling unit 90 may blow cold air onto the formed product 41 on a conveyor. The cooling unit 90 may blast dry ice. Alternatively, a device such as a refrigerator that accommodates the formed product 41 in a low-temperature atmosphere may be adopted as the cooling unit 90.

The formed product 41 taken out from the forming die 2 is in a high-temperature state. In a case where the machining is performed in the high-temperature state, the machining accuracy decreases due to the influence of cooling contraction during a temperature fall. For that reason, it is necessary to lower the temperature of the formed product 41 before the machining. In contrast, the forming system 200 further includes a cooling unit 90 that actively cools the formed product 41 removed from the forming die 2, and the laser machining device 70 machines the formed product 41 cooled by the cooling unit 90. By actively cooling the formed product 41 via the cooling unit 90, it is possible to reduce the time required for the machining as compared to a case where heat naturally dissipates.

### Still Another Embodiment

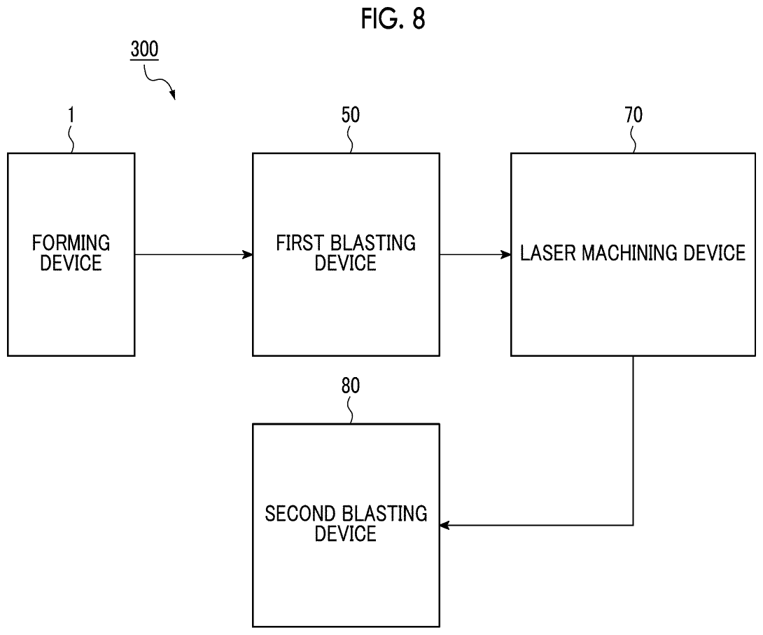

Next, a forming system 300 according to still another embodiment will be described with reference to FIG. 8. As shown in FIG. 8, the forming system 300 includes a first blasting device 50 disposed in a stage before the laser machining device 70 and a second blasting device 80 that removes scales from the formed product 41 machined by the laser machining device 70. In addition, here, the first blasting device 50 corresponds to a “cooling unit” in the claims, and the second blasting device 80 corresponds to a “scale removing unit” in the claims. In this case, the first blasting device 50 may jet dry ice as the particles 55. Even if the first blasting device 50 jets the particles 55 other than the dry ice, a cooling effect can be obtained due to the influence of blowing air, but a high cooling effect can be obtained by jetting the dry ice.

As shown in FIG. 5B, the second blasting device 80 jets the particles 55 from the blast hose 56 onto the inner peripheral surface of the formed product 41. The blast hose 56 is inserted inside the formed product 41 and ejects the particles toward an inner peripheral surface inside the formed product 41. In this case, the blast hose 56 may jet the dry ice as the particles 55. Although the dry ice collides against the inner peripheral surface of the formed product 41 as solid matter to remove the scales, the dry ice turns into gas and disappears with the elapse of time. Therefore, it is possible to prevent the particles 55 from remaining on the flange portion 44.

In addition, the first blasting device 50 and the second blasting device 80 may be constituted by a common device. For example, the blast hose 56 of FIG. 5B may be added to the blasting device 50 of FIG. 5A. In such a blasting device, in a first blasting process, the nozzle 52 performs blasting on the outer peripheral surface of the formed product 41, and in a second blasting process, the blast hose 56 performs blasting on the inner peripheral surface of the formed product 41. From the above, the number of devices of the forming system 200 can be reduced.

The present invention is not limited to the above-described embodiment.

In the above-described embodiment, the blasting device has been exemplified as a scale removing unit. However, any device may be adopted as the scale removing unit as long as the device can remove the scales. For example, a method of jetting the fluid onto the formed product or removing the scales via ultrasonic cleaning may be adopted. Such a scale removing unit also has a cooling effect.

The machining unit is not limited to the laser machining device, and a device using another machining method may be adopted.

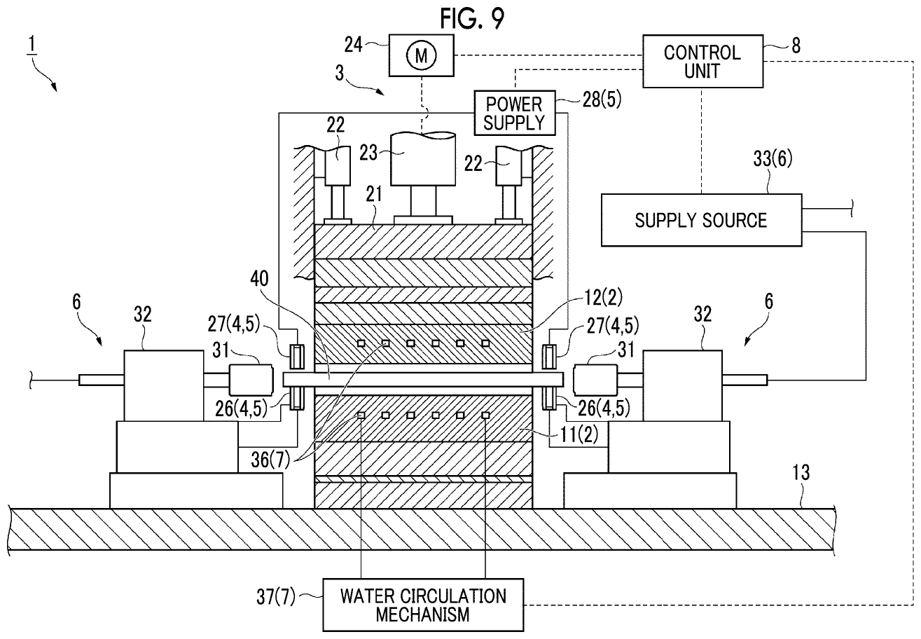

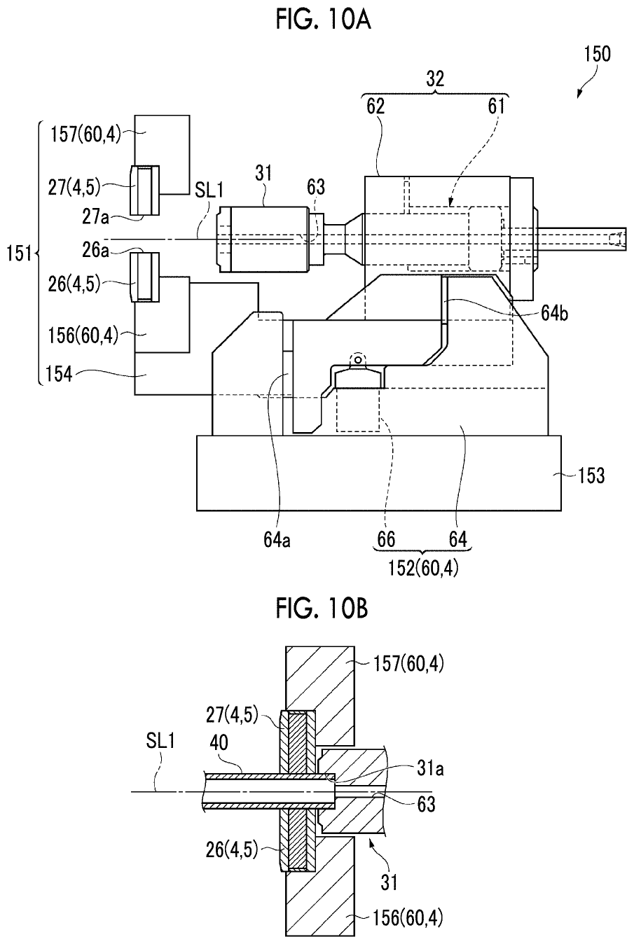

The forming device 1 is not limited to the configuration shown in FIG. 2, and, for example, a configuration shown in FIG. 9 may be adopted as the forming device 1. In the forming device 1 shown in FIG. 9, a heating and expanding unit 150 as shown in FIG. 9 may be adopted. FIG. 10A is a schematic side view showing the heating and expanding unit 150 in which the components of the holding unit 4, the heating unit 5, and the fluid supply unit 6 are unitized. FIG. 10B is a cross-sectional view showing an aspect when the nozzle 31 has sealed the metal pipe material 40.

As shown in FIG. 10A, the heating and expanding unit 150 includes the above-described lower electrode 26 and upper electrode 27, an electrode mounting unit 151 on which the electrodes 26 and 27 are mounted, the above-described nozzle 31 and drive mechanism 32, an elevating unit 152, and a unit base 153. The electrode mounting unit 151 includes an elevating frame 154 and electrode frames 156 and 157. The electrode frames 156 and 157 function as a part of a drive mechanism 60 that supports and moves the electrodes 26 and 27, respectively. The drive mechanism 32 drives the nozzle 31 and lifts and lowers together with the electrode mounting unit 151. The drive mechanism 32 includes a piston 61 that holds the nozzle 31, and a cylinder 62 that drives the piston. The elevating unit 152 includes elevating frame bases 64 attached to an upper surface of the unit base 153, and an elevating actuator 66 that applies an elevating operation to the elevating frame 154 of the electrode mounting unit 151 via the elevating frame bases 64. Each elevating frame base 64 has guide portions 64a and 64b that guide the elevating operation of the elevating frame 154 with respect to the unit base 153. The elevating unit 152 functions as a part of the drive mechanism 60 of the holding unit 4. The heating and expanding unit 150 has a plurality of unit bases 153 having different inclination angles of the upper surface, and is allowed to collectively change and adjust the inclination angles of the lower electrode 26 and the upper electrode 27, the nozzle 31, the electrode mounting unit 151, the drive mechanism 32, and the elevating unit 152 by replacing the unit bases 153.

The nozzle 31 is a cylindrical member into which the end portion of the metal pipe material 40 is insertable. The nozzle 31 is supported by the drive mechanism 32 such that a center line of the nozzle 31 coincides with a reference line SL1. An inner diameter of a feed port 31a of an end portion of the nozzle 31 on the metal pipe material 40 side substantially coincides with an outer diameter of the metal pipe material 40 after expansion forming. In this state, the nozzle 31 supplies the high-pressure fluid from an internal flow path 63 to the metal pipe material 40. In addition, an example of the high-pressure fluid is gas or the like.

It should be understood that the invention is not limited to the above-described embodiment, but may be modified into various forms on the basis of the spirit of the invention. Additionally, the modifications are included in the scope of the invention.

What is claimed is:

1. A forming system comprising:
a forming device including a fluid supply unit that supplies a fluid to a heated metal pipe material, and a forming die that forms a formed product by bringing an expanded metal pipe material into contact with a forming surface;
a machining unit that machines the formed product removed from the forming die; and
a scale removing unit that removes scales from the formed product machined by the machining unit.

2. The forming system according to claim 1,
wherein the scale removing unit removes the scales from the formed product by causing particles to collide against the formed product.

3. The forming system according to claim 2,
wherein the scale removing unit includes a nozzle that jets the particles to the formed product, an installation portion that installs the formed product at a position facing the nozzle, and a blockade wall that is a wall body that blocks the particle.

4. The forming system according to claim 3,
wherein the nozzle is disposed such that a jetting port faces an outer peripheral surface of the formed product, and
the blockade wall is disposed to surround peripheries of the installation portion and the nozzle.

5. The forming system according to claim 4,
wherein a wall portion that partitions a space between the scale removing unit and the machining unit is provided.

6. The forming system according to claim 1, further comprising:
a cooling unit that actively cools the formed product removed from the forming die,
wherein the machining unit machines the formed product cooled by the cooling unit.

7. The forming system according to claim 1,
wherein the fluid supply unit is provided on both end sides of the forming die in a longitudinal direction, and
the fluid supply unit includes a nozzle that supplies a fluid to an inside of the metal pipe material, a drive mechanism that moves the nozzle forward and backward with respect to an opening of the metal pipe material, and a supply source that supplies a high-pressure fluid into the metal pipe material via the nozzle.

8. The forming system according to claim 1,
wherein the machining unit includes a laser head that irradiates the formed product with a laser beam, and an installation portion in which the formed product is installed at a position facing the laser head.

9. The forming system according to claim 8,
wherein the installation portion includes a support portion that supports the formed product, and
the laser head irradiates the formed product with a laser beam and cuts a formed body portion of the formed product to remove a gradual change portion and a held portion of the formed product from the formed body portion.

10. A forming method comprising:
a forming process of supplying a fluid to a heated metal pipe material and bringing an expanded metal pipe material into contact with a forming surface of a forming die to form a formed product;
a machining process of machining the formed product removed from the forming die; and
a scale removing process of removing scales from the formed product machined in the machining process.
